(19) United States
(12) Patent Application Publication
(10) Pub. No.: US 2006/0115377 A1
(43) Pub. Date: Jun. 1, 2006

(54) Transparent ITO-heating capillary reactor

(76) Inventors: Jianzhong Fu, New Orleans, LA (US); Yunfeng Lu, New Orleans, LA (US); Kyriakos D. Papadopoulos, New Orleans, LA (US)

Correspondence Address: Jiangzhong Fu, 1318 W Esplanade Avn, Apt M, Kenner, LA, 70065, US

(21) Appl. No.: 10/946,409

(22) Filed: Sep. 21, 2004

Related U.S. Application Data
(60) Provisional application No. 60/505,647, filed on Sep. 24, 2003.

(51) Int. Cl. G01N 15/00

(52) U.S. Cl. 422/50; 422/68.1

(57) ABSTRACT

The present invention comprises a transparent and electrically conductive glass capillary for the purpose of containing and heating fluids inside the capillary on the stage of a microscope and a method to investigate and characterize acid neutralization by overbased additives in lubricant oils. The heating capillary was prepared by coating a transparent ITO film on the outside surface of the capillary as an electrically heating jacket. It can generate at least 287° C. when applied appropriate voltage. The desired temperature can be attained at a rate ranging from 75° C./s to 198° C./s and be easily adjusted by changing the supplied voltage.

### RELATED APPLICATION

This application is based upon U.S. provisional application Ser. No. 60/505,647, filed Sep. 24, 2003.

### FIELD OF THE INVENTION

This invention relates to high-temperature video-microscopy. In particular, the invention relates to a method of evaluating performances of lubricating oils comprising overbased detergent additives at high temperatures and to a device for the implementation of this method.

### BACKGROUND OF THE INVENTION

Acid components that formed during fuel combustion and lubricating oil degradation must be neutralized rapidly to prevent engine parts from corrosive wear. Particularly, marine diesel engines generally use heavy fuels with high sulfur content; sulfuric acid droplets will be formed at cylinder wall and encroached into lubricating film. The ability to neutralize highly corrosive sulfuric acid is one of key concerns in the formulation of marine cylinder lubricants.

The acid neutralization properties of overbased detergents have been studied for many years. Recently, the introduction of exhaust gas recirculation systems to combustion engines has increased demands on the acid neutralization performance of base lubricants.

Knowledge of the mechanisms of the acid-neutralizing reaction, the rate of such neutralization, and how temperature and surfactant structure will affect the rate of neutralization, is very important to select appropriate detergents and surfactants and to optimize the performance of lubricant formulation.

Studies in this field include: Warren Lowe (1974, U.S. Pat. No. 3,856,687), Kiyoshi Inoue and Takashi Mito (1988, Nisseki Rebyu 30(5), pp 197-201), developed methods to test the rate of neutralization by measuring the changes of pH; J-P Roman (1998, CIMAC Congress, pp 913-925; 2001, U.S. Pat. No. 6,245,571B1), Katafuchi Tadashi (1999, U.S. Pat. No. 5,980,829), by measuring the changes of pressure of produced CO₂; Brain L. Papke (1988, Tribology Transactions 31(4), pp 420-426), developed an IR spectroscopic technique; Rong C. Wu et al. (1999, AlChE Journal 45(9), pp 2011-2017), by using a capillary video-microcopy system at ambient temperature; Duncan C. Hone et al. (2000, Langmuir 16(2), pp 340-346), by employing a stopped-flow technique; and Jane Galsworthy et al. (2000, Current Opinion in Colloid & Interface Science 5(5-6), pp 274-279) and Duncan C. Hone et al. (2001, Surfactant Science Series 100, pp 385-394), reviewed techniques and progresses in this field, respectively.

Among the aforementioned publications, our previous technique (Wu, 1999), based upon a capillary video-microscopy system, provided a unique way to qualify and quantify the acid neutralization by overbased detergents. The detailed reaction information can be visually observed and recorded in real time. Its limitation is that the capillary video-microscopy can only be carried out at ambient temperatures.

The need to investigate the acid neutralization at temperatures similar to those of lubricating films inside combustion engines demands effective means to heat the capillary reactor on the stage of microscope. Because the dimension of the capillary reactor is <8 mm in observation length and <300 μm in outside diameter, typical heating stages of microscopes and heating devices for microscope are useless to heat samples inside the capillary reactor.

The object of the present invention is specially to overcome the heating problem of the capillary reactor and in particularly to provide a process and a device for visually observing and recording the acid neutralization of lubricants at conditions similar to the true environment in engines: high temperature, confined space, and condensed acid components in the form of droplets. The ability of the present invention to simulate these conditions cannot be entirely reached through any of the methods and techniques described in the aforementioned publications.

The method to heat the capillary reactor is to make itself electrically conductive by coating a transparent conductive film of tin-doped indium oxide (ITO) on the outside surface of the capillary.

ITO film has been extensively used in transparent electrode in display and optoelectronic devices, electrochromatic devices, solar cells, and sensors, etc. It is also used as a heater. Studies and patents closely relates to our technique are: “Thin Film Tubular Heater” (Richard P. Cooper, 2002, U.S. Pat. No. 6,376,816B2), “Transparent Body with Heater” (Nagaoka Makoto, 2002, JP2002134254), “ITO heater” (K. P. Ho et al., 2002, U.S. Pat. No. 2002/0089638A1), and “Capillary Tube Resistive Thermal Cycling” (Neal A. Friedman and Deirdre R. Meldrum, 1998, Anal. Chem. 70(14) pp 2997-3002). However, none of them was reported targeting on such a tiny heating volume and could reach a rapid heating rate as our technique could.

### SUMMARY OF THE INVENTION

The present invention provides a device and methods of observing visual changes in liquids at microscopic level and at varying temperatures. Particularly, the invention provides a novel means to visually investigate acid neutralization by base lubricants at high temperatures and to characterize the rate of such neutralization.

The key part of the present invention comprises a thin-wall glass capillary and a transparent ITO film deposited on the outside surface of the capillary. The coated ITO film acts as an electrically heating jacket, connecting to an electrical output source by copper wiring, and can generate at least 287° C. The desired temperature can be attained at a rate ranging from 75° C./s to 198° C./s and be easily adjusted by changing the supplied voltages.

### BRIEF DESCRIPTION OF DRAWING

FIG. 1 is a schematic diagram, showing a heating capillary reactor;

FIG. 2 is a schematic diagram, showing a high-temperature video-microscopy with the heating capillary reactor;

FIG. 3 is a plot of temperature-time curves, showing the fast heating and cooling rates of a heating capillary;

FIG. 4 is a series of snapshots captured from recorded color video of the process of acid neutralization at 110-140° C., showing the rate of neutralization can be characterized by a “break-down” time;

FIG. 5 is a series of snapshots captured from recorded color video of the process of acid neutralization at room temperature, showing the rate of neutralization can be characterized by the shrinking rate of acid droplet;

FIG. 6 is a series of snapshots captured from recorded color video of the process of air bubbles, showing air bubble coalescence as the result of thermal expansion at 60-80° C.

### DETAILED DESCRIPTION OF THE INVENTION

The present invention comprises a transparent and electrically conductive glass capillary for the purpose of containing and heating fluids inside it on the stage of a microscope and a method to investigate and characterize acid neutralization by overbased additives in lubricating oils.

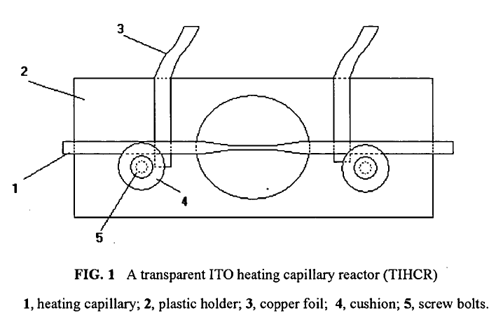

Heating capillary preparation and assembly Refer to FIG. 1, the key part of the invention is a heating capillary 1, made from a silicate glass tube that is pulled to about 300 μm thin in outside diameter and 8 mm in length at its observation area (the narrowest region). The composition of precursor solution, the rate of dip coating, and the temperature and time of annealing are the key factors impacting on the properties of ITO films. For our purpose, the rate of dip coating is controlled at 6-24 cm/min; the precursor solution is a 1:4-1:7 diluted solution of a sol-gel ITO product purchased from Chemat Company; the annealing process is accomplished by heating at 425-550° C. for 3 hours. The capillary is repeatedly coated until the ITO layer resistance reaches 100 KΩ or less.

To reduce movements that might damage it, the heating capillary is fixed on a plastic holder 2, which provides the connection between the capillary and the output cable of a voltage transformer via two copper foils 3. The plastic holder has three openings and a groove on the surface across the entire length. The center opening provides enough space to let visible light go through; while the other small openings contain cushions 4 and screw bolts 5 allow fixing the capillary on the groove. The soft copper foils are also used as buffers to reduce the moving forces caused by alligator clips of the cable connecting to the transformer, which can supply electricity power of 0˜120/140 V and maintain appropriate current for desired temperatures.

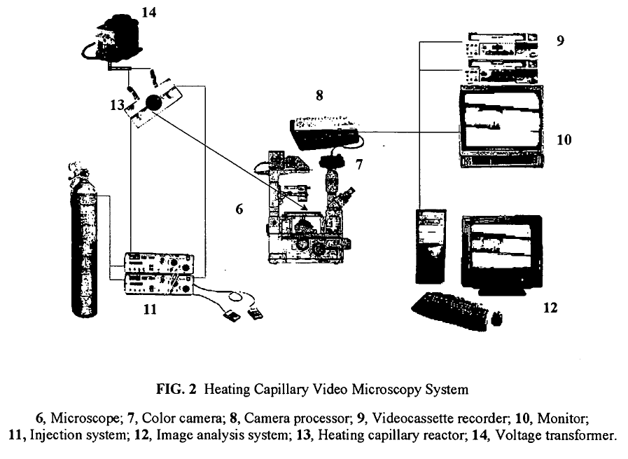

High-temperature video-microscopy system Refer to FIG. 2, the heating capillary video microscope system consists of a microscope 6, a high-performance color camera 7 and its processor 8, videocassette recorders 9 and monitor 10, a injection device 11, a personal computer 12 equipped with image analysis software, and a heating capillary reactor 13, placed on the stage of the microscope and connected to a voltage transformer 14.

Heating and cooling rates An embodiment of the present invention was fabricated in accordance with the above procedures. A one-end-closed silicate glass tube (Corning 9530-3) was pulled as a thin-wall capillary with about 300 μm in outside diameter and about 6 mm in length. The sol-gel processing procedure was controlled by selecting parameters as: dip coating rate, 8 cm/min; precursor solution, 1:7 dilution; annealing temperature and time, 450° C. and 3 hours, respectively. The capillary was repeatedly coated until the ITO layer resistance reached 52.2-63.8 KΩ after assembled on the plastic holder.

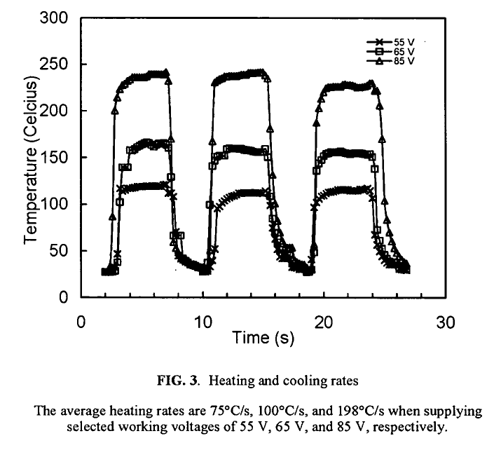

The embodiment of present invention could generate at least 287° C. temperature, the boiling temperature of n-hexadecane. The heating capillary boiled n-hexadecane filled inside it through supplying voltage near 100 V. The embodiment had very fast heating and cooling rates, as shown in FIG. 3. Its average heating rates are 75° C./s, 100° C./s, and 198° C./s when supplying selected working voltages of 55 V, 65 V, and 85 V, respectively. The capability of rapidly heating and cooling liquids inside the capillary enables high-temperature video-microscopy can be carried out at desired temperatures immediately whenever needed.

Acid Neutralization With the embodiment of the present invention, acid neutralization can be simulated at conditions similar to that of lubricating film inside a real combustion engine: high temperature, confined space, and acid droplets. After setup the high-temperature video-microscopy system shown in FIG. 2, the detailed acid neutralization can be visually observed and recorded.

The heating capillary 1 was first filled with the model oils comprising overbased detergents, then placed on the stage of the microscope 6 and connected to the transformer 14. The temperature was measured by specially designed thermocouples (not shown, purchased from Paul Beckman Company), which can be positioned at the center of the capillary through inserting it into one end of the capillary. Sulfuric acid droplets were injected into the capillary through another end of the capillary by a specially prepared micropipette (not shown, pulled from glass tube). To form appropriate acid droplets inside oil, both the internal wall of the heating capillary and the external surface of the injection micropipette must be hydrophobically treated. The size of the acid droplet can be controlled by the injection system 11 shown in FIG. 2 and precisely measured by using Image-Pro Plus software 12.

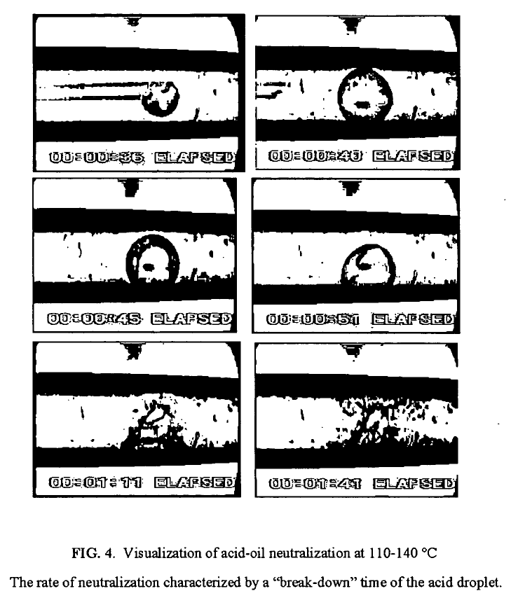

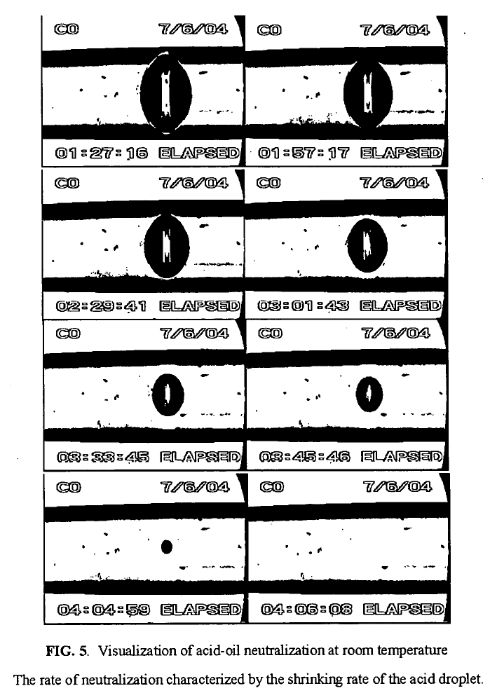

Refer to FIG. 4 and FIG. 5. The snapshots show the changes of sulfuric acid droplets in model oils comprising overbased additives. In FIG. 4, the rate of neutralization characterized by a “break-down” time of the acid droplet. The sulfuric acid droplet was injected at 00:00:36 (hh:mm:ss), acid neutralization was performed at temperature of 110-140° C. It was observed that reaction products, CaSO₄ crystals and CO₂ gas, were formed inside the acid droplet. The sulfuric acid droplet started to break, losing its entity of a droplet, at the snapshot of 00:01:41. In FIG. 5, the rate of neutralization characterized by the shrinking rate of the acid droplet. The acid neutralization was performed at room temperature. The sulfuric acid droplet with a height of 204.9 μm at the snapshot of 01:27:16 was observed to disappear at the snapshot of 04:06:08. No product could be observed during the reaction.

Not only the rate of neutralization can be characterized with the present invention; but also the detailed reaction processes, such as the location in which the reaction products will be formed, the morphology of the CaSO₄, and whether or not the products are observed, can be visually investigated. Knowledge about these details is very helpful to improve the performance of lubricating oils.

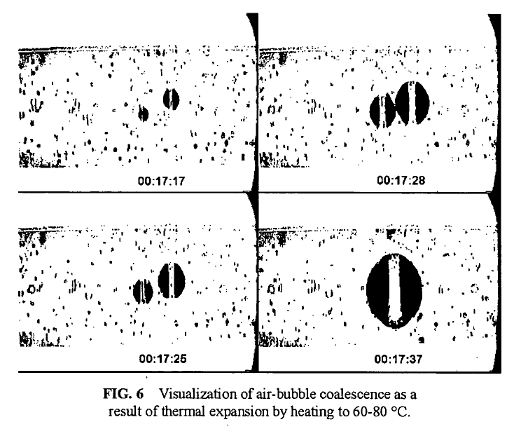

Air bubble coalescence The present invention can also be used to study the coalescence of air bubble in water as a result of thermal expansion. Refer to FIG. 6, at snapshot of 00:17:17, the bubbles appeared to have the heights of 42 and 64 μm, respectively, at ambient temperature. When the temperature was raised to 60-80° C., the bubbles grew, contacted, then coalesced and formed a bigger bubble with the height of 168 μm at snapshot of 00:17:37.

The present invention is not limited to investigate acid-neutralizing behaviors by overbased additives in lubricating oils. Phenomena involving biphasic dispersions with interfaces at varying temperature and visual changes at micron level can also be studied, such as hetero-aggregation, droplet coalescence, cell motility, electrokinetic transport, etc. It also has potential application in investigating the behavior of extremophilic organisms and the stability of and transport in double-emulsion systems.

What is claimed is:

1. A method of containing and heating fluids inside a capillary on the stage of a microscope.

2. The method according to claim 1, wherein the capillary is pulled to have less than 300 μm in outside diameter and less than 8 mm in length (the narrowest region).

3. The method according to claim 1, wherein the capillary is deposited a film of tin-doped indium oxide on its outside surface.

4. The method according to claim 1, wherein the capillary can generate temperature ranging from ambient temperature to at least 287° C. when applied appropriate voltages.

5. The method according to claim 1, wherein the capillary has rapid heating and cooling rates. The average heating and cooling rates range from 75-198° C./s when applied appropriate voltages.

6. The method according to claim 1, wherein the capillary is transparent in visible light region so as to allow performing video microscopy.

7. A method of simulating acid neutralization by overbased additives in lubricating oils in conditions similar to those of lubricating films inside real combustion engines: high temperature (ambient temperature to 260° C.), confined space (less than 250 μm), and acid components in the form of droplets (diameter less than 250 μm).

8. A method of visually observing and recording acid-neutralizing behaviors by overbased additives in lubricating oils at high temperatures.
